(19) United States
(12) Patent Application Publication
(10) Pub. No.: US 2026/0040210 A1
(43) Pub. Date: Feb. 5, 2026

(54) POWER SAVINGS IN A HYBRID MOBILE NETWORK

(71) Applicant: Charter Communications Operating, LLC, St. Louis, MO (US)

(72) Inventor: Saran Khalid, Denver, CO (US)

(73) Assignee: Charter Communications Operating, LLC, St. Louis, MO (US)

(21) Appl. No.: 18/794,541

(22) Filed: Aug. 5, 2024

(51) Int. Cl. H04W 52/02

(52) U.S. Cl. CPC H04W 52/0206

(57) ABSTRACT

Methods and systems for saving power in a hybrid mobile network in view of traffic usage and operational costs. A method includes employing, by a service provider, a first wireless network and a second wireless network, wherein the first wireless network is controlled by the service provider and the second wireless network is not controlled by the service provider, receiving, by a cost power engine from an operations support system, traffic usage information from one or more base stations of the first wireless network to turn off power to base stations at the first wireless network. The method can include generating, by the cost power engine, a power off list based on the traffic usage information falling below a cost power off threshold, and sending, by the cost power engine to service provider components, the power off list to turn off power to base stations on the power off list.

### TECHNICAL FIELD

This disclosure relates to wireless communications. More specifically, power saving techniques in a hybrid mobile network in view of traffic usage and operational costs.

### BACKGROUND

Service providers can deploy hybrid mobile networks to provide wireless communications to its subscribers or customers. In this instance, the service provider may be referred to as a hybrid mobile network operator (HMNO). The hybrid mobile networks can consist of a service provider network, which the service provider owns and operates, and a multiple virtual network operator (MVNO) network, which the service provider deploys via other wireless providers or mobile network operators (MNOs). The service providers pay fees to the MNOs for data traffic on the MVNO network. As such, the hybrid mobile network or HMNO network enables the service provider to offload traffic from the MVNO network to the service provider network.

The offload volume or tonnage from the MVNO network to the service provider network can vary from peak offload volume during busy hour(s) to significantly low offload volume during nighttime, for example. During these low offload volume times, however, base stations in the service provider network will draw nearly the same amount of power from a power source. For example, a base station may use 90 watts as opposed to 80 watts during low offload volume times. Costs for keeping the base stations on during low offload volume times can add up due to the number of base stations deployed in the service provider network. The costs and energy for continuously operating the base stations during low utilization is not cost or energy efficient or environmentally friendly.

### SUMMARY

Disclosed is a system and method for saving power in a hybrid mobile network in view of traffic usage and operational costs. In implementations, a method for power savings in a wireless network includes employing, by a service provider, a first wireless network and a second wireless network, wherein the first wireless network is controlled by the service provider and the second wireless network is not controlled by the service provider, receiving, by a cost power engine from an operations support system, traffic usage information from one or more base stations of the first wireless network to turn off power to base stations at the first wireless network. The method can include generating, by the cost power engine, a power off list based on the traffic usage information falling below a cost power off threshold, and sending, by the cost power engine to service provider components, the power off list to turn off power to base stations on the power off list.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example of a wireless network architecture in accordance with embodiments of this disclosure.

FIG. 2 is a diagram of an example of a net present value or cost threshold with respect to traffic usage over time in accordance with embodiments of this disclosure.

FIG. 3 is a diagram of an example of coverage areas in accordance with embodiments of this disclosure.

FIG. 4 is a flow diagram of an example of a system saving power based on net present value in accordance with embodiments of this disclosure.

FIG. 5 is a flow diagram of an example of a system saving power based on net present value in accordance with embodiments of this disclosure.

FIG. 6 is a flowchart of an example method for saving power based on net present value in accordance with embodiments of this disclosure.

FIG. 7 is a flowchart of an example method for saving power based on net present value in accordance with embodiments of this disclosure.

FIG. 8 is a block diagram of an example of a device in accordance with embodiments of this disclosure.

### DETAILED DESCRIPTION

Reference will now be made in greater detail to embodiments, examples of which are illustrated in the accompanying drawings. Wherever possible, the same reference numerals will be used throughout the drawings and the description to refer to the same or like parts.

As used herein, the terminology “server”, “computer”, “computing device or platform”, or “cloud computing system” includes any unit, or combination of units, capable of performing any method, or any portion or portions thereof, disclosed herein. For example, the “server”, “computer”, “computing device or platform”, or “cloud computing system” may include at least one or more processor(s).

As used herein, the terminology “processor” or “processing circuitry” indicates one or more processors, such as one or more special purpose processors, one or more digital signal processors, one or more microprocessors, one or more controllers, one or more microcontrollers, one or more application processors, one or more central processing units (CPU) s, one or more graphics processing units (GPU) s, one or more digital signal processors (DSP) s, one or more application specific integrated circuits (ASIC) s, one or more application specific standard products, one or more field programmable gate arrays, any other type or combination of integrated circuits, one or more state machines, or any combination thereof.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory and hardware that is hard-wired into the processing circuitry.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the term “memory” includes one or more memories, where each memory may be a computer-readable medium. A memory may encompass memory hardware units (e.g., a hard drive or a disk) that store data or instructions in software form. Alternatively or in addition, the memory may include data or instructions that are hard-wired into processing circuitry. The memory may include a single memory unit or multiple joint or disjoint memory units, which each of the multiple joint or disjoint memory units storing all or a portion of the data described as being stored in the memory.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. For example, the memory can be non-transitory. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks, or activities. For example, applications may perform one or more functions including, but not limited to, telephony, web browsers, e-commerce transactions, media players, scheduling, management, smart home management, entertainment, and the like. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure and claims. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described embodiments that are relevant for a clear understanding of the herein disclosed processes, machines, and/or manufactures, while eliminating for the purpose of clarity other aspects that may be found in typical similar devices, systems, and methods. Those of ordinary skill may thus recognize that other elements and/or steps may be desirable or necessary to implement the devices, systems, and methods described herein. However, because such elements and steps do not facilitate a better understanding of the disclosed embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

Described herein is a system and method for saving power in a hybrid mobile network based on net present value in accordance with embodiments of this disclosure.

In implementations, a service provider using a hybrid mobile network employs a service provider network and a multiple virtual network operator (MVNO) network. In most instances, the MVNO network is continuously on and provides sufficiently overlapping coverage with that provided by the service provider network. The system and method described herein provides mechanisms for turning off and on base stations and/or radios based on traffic usage and/or offload usage. A net present value (NPV) or cost of traffic usage and/or offload usage (collectively “data usage”) can be used to power off and power on base stations in the service provider network. Service provider provided mobile devices, which are equipped or provisioned as dual Subscriber Identity Module (SIM) and dual subscription (DSDS) devices, can automatically transition to the MVNO network when the base stations are powered off. Consequently, power and costs are conserved and/or minimized when there is little to no traffic or data offload opportunity. In implementations, the base stations can be powered on when the data usage reaches a NPV breakeven point with respect to the cost of running the base stations and/or network (e.g., cost of power among other factors) and the savings provided by data offloading (offload savings from not using the MVNO network). The service provider provided mobile devices can transition to the service provider network when appropriate. In implementations, cost or NPV power off and power on thresholds can be based on historical traffic usage patterns in the hybrid mobile network.

In implementations, a radio power efficiency function and/or engine (RPEF) or cost power engine or controller can subscribe to messages from a service provider connection manager for information related to the MVNO traffic usage and to an operations support system (OSS) for information related to the service provider network traffic usage. The RPEF can determine a NPV value(s) for the service provider network traffic usage for one or more base stations, one or clusters, the service provider network, and/or combinations thereof. Each NPV value can be compared against a cost or NPV power off threshold to determine candidate base stations and/or clusters. In implementations, the RPEF can consider a variety of coverage factors when generating a power off list of base station(s) and/or clusters to power off. The variety of coverage factors can include, but is not limited to, user experience, MVNO status, handoff issues, and coverage jumping (e.g., unwanted switching between the two networks due to powering off a middle or intermediate base station). The power off list can be provided to a cable modem termination system (CMTS). The CMTS can switch off the base station(s) and/or cluster(s) on the power off list. In implementations, an alarm notification can be sent to the OSS that the base station(s) and/or cluster(s) have been turned off.

In implementations, the RPEF can generate a NPV value based on the messages with respect to the MVNO traffic usage. Each NPV value can be compared against a NPV power on threshold to determine candidate base stations and/or clusters. In implementations, the RPEF can consider the variety of coverage factors when generating a power on list of base station(s) and/or clusters to power on. A power on list can be generated and send to the CMTS. The CMTS can switch on the power to the base station(s) and/or cluster(s) which are on the list. In implementations, an alarm notification can be sent to the OSS that the base station(s) and/or cluster(s) have been turned on.

In implementations, the methods and systems herein provide mechanisms to turn off and on the base station(s), cluster(s), and/or radio(s) such that the base station(s), cluster(s), and/or radio(s) are only operating when there is significant offload opportunity as represented by the NPV power on and power off thresholds. Thus, reducing the carbon footprint as well as the overall electricity bill of operating the network.

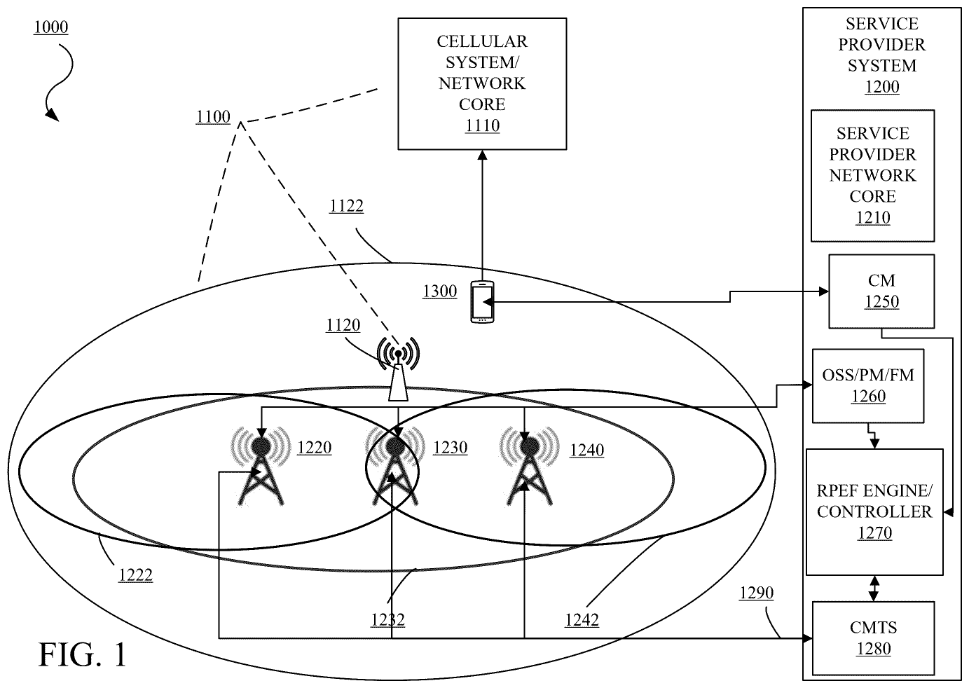

FIG. 1 is a diagram of an example wireless network architecture 1000. The wireless network architecture 1000 can include, but is not limited to, a wireless or cellular system or network (collectively “wireless system”) 1100 and a service provider system or network 1200. The wireless network architecture 1000 can implement any wireless technology including, but not limited to, third generation (3G), fourth generation (4G), and fifth generation (5G) wireless communications and/or networks, and CBRS or shared spectrum wireless technologies and/or networks. In implementations, the wireless network architecture 1000 can be a hybrid mobile virtual network operator (HMNO) network where a service provider, which owns and operates the service provider system 1200 (e.g., as a multiple systems operator (MSO), and can operate the wireless system 1100 as a mobile virtual network operator (MVNO). The wireless system 1100 is owned by another and/or a third party. The number of components shown herein are illustrative and there may be more or less in the wireless network architecture 1000. The wireless network architecture 1000 and the components therein may include other elements which may be desirable or necessary to implement the devices, systems, and methods described herein. However, because such elements and steps do not facilitate a better understanding of the disclosed embodiments, a discussion of such elements and steps may not be provided herein.

In implementations, the wireless system 1100 can include, but is not limited to, a core network 1110 and a base station 1120, and can provide a wireless network. The number of base stations shown herein is illustrative and there may be more or less in the wireless system 1100. In implementations, the core network 1110 can include various functional components to address mobility management, authentication, session management, and other related functions with respect to, for example, the base station 1120. The base station 1120 can be an eNodeB, gNodeB, base station, and/or like device which enables radio communications access between a mobile device 1300 and other devices in a wireless coverage area 1122 of the base station 1120. The base station 1120 can support wireless communications via one or more of the 3G, the 4G, the 5G, and CBRS wireless technologies and/or networks.

The service provider system 1200 can include, but is not limited to, a service provider network core 1210, one or more base stations 1220, 1230, and 1240, a connection manager (CM) server 1250, an operations support system (OSS)/performance manager (PM)/fault manager (FM) 1260, a RPEF or cost power engine or controller (RPEF engine) 1270, and a cable modem termination system (CMTS) power and switch (collectively “CMTS”) 1280, and can provide a service provider network. The service provider network core 1210 can include various functional components to address mobility management, authentication, session management, and other related functions with respect to, for example, the one or more base stations 1220, 1230, and 1240. In implementations, the one or more base stations 1220, 1230, and 1240 can be an access point, an access node, gNodeB, cable modem/router/integrated device, small cell base station, low-powered cellular radio access node, small, low-power base station, and/or like device which enables radio communications access between the mobile device 1300 and other devices in the respective wireless coverage areas. The base station 1120 can support wireless communications via one or more of the 3G, the 4G, the 5G, the CBRS wireless technology, WiFi, and/or other technologies. In implementations, the one or more base stations 1220, 1230, and 1240 and the CMTS 2300 are connected via a hybrid-fiber-coaxial (HFC) infrastructure 1290 implementing Data Over Cable Service Interface Specification (DOCSIS). In implementations, the one or more base stations 1220, 1230, and 1240 are installed on strand which gets its power from local power supplies i.e., powering infrastructure for DOCSIS plant nodes. That is, the one or more base stations 1220, 1230, and 1240 are installed on DOCSIS plant and draws power from the same source of energy. In implementations, the OSS 1260 and the RPEF engine 1270 can be logically separate, logically integrated, physically separate, physically integrated, and/or combinations thereof. In implementations, the RPEF engine 1270 can be a server, a cloud based platform, distributive, and/or combinations thereof.

The CM server 1250 can obtain traffic usage information or traffic utilization data from the mobile device 1300. In implementations, the CM server 1250 can obtain traffic usage information from the mobile device 1300 when some of one or more base stations 1220, 1230, and 1240, and or clusters thereof are powered off and the mobile device 1300 is using the wireless system 1100 as a mobile virtual network operator (MVNO) network of the service provider. The CM server 1250 can send the traffic usage information to the RPEF engine 1270 for powering on and/or off determinations based on NPV thresholds.

The OSS 1260 can work with the service provider network core 1210, the RPEF engine 1270, the CMTS 1280, and the other components in the service provider system 1200 to power down one or more base stations 1220, 1230, and 1240, and/or clusters thereof when the RPEF engine 1270 has determined a NPV value, which is based on traffic usage information, has breached, or fallen below a NPV power off threshold. In implementations, OSS 1260 can work with the service provider network core 1210, the RPEF engine 1270, the CMTS 1280, and the other components in the service provider system 1200 to power down one or more base stations 1220, 1230, and 1240, and/or clusters thereof when the RPEF engine 1270 has determined a NPV value, which is based on traffic usage information, has breached or risen above a NPV power on threshold. The OSS 1260 can obtain or receive from the one or more base stations 1220, 1230, and 1240 key performance indicators (KPIs) and/or counters. These KPIs and/or counters are a good indicator of the network utilization, number of mobile devices, and traffic usage (collectively “traffic usage information or traffic utilization data”). The OSS 1260 can send the traffic usage information to the RPEF engine 1270.

The RPEF engine 1270 can subscribe to messages from the CM 1250 and the OSS 1260 to receive traffic usage related messages to obtain traffic usage information. The RPEF engine 1270 can review one or more of the traffic usage information to determine offload usage, i.e., cell tonnage or network tonnage in downlink (DL), uplink (UL), and/or both. A NPV can be determined based the traffic usage information. The RPEF engine 1270 can use NPV power on and power off thresholds to power on and off, respectively, base stations (candidate base stations). In implementations, the RPEF engine 1270 can apply a variety of factors to the candidate base stations to generate a list of base stations to power on or off, as appropriate.

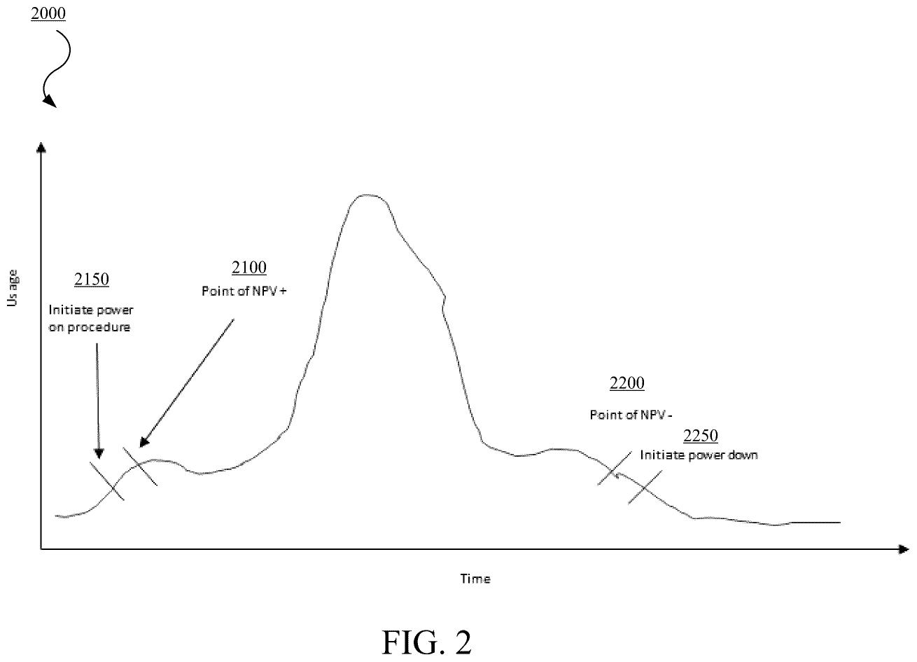

The NPV power on and power off thresholds are illustrated in FIG. 2, which is a diagram of an example graph 2000 of a net present value or cost threshold with respect to traffic usage over time in accordance with embodiments of this disclosure. The graph 2000 can represent traffic usage patterns in a HMNO network. As shown, traffic usage varies over time. The graph 2000 can be used to determine a NPV power on threshold 2100, which can represent a point where traffic usage is significant, e.g., where the cost of powering the one or more base stations is offset by the cost savings from offloading traffic from the wireless system 1100 to the service provider system 1200. In implementations, there is period of time or a grace period needed to turn on the one or more base stations. This can be accounted for by initiating a powering on process at an earlier point, i.e., power on initialization point 2150. Similarly, the graph 2000 can be used to determine a NPV power off threshold 2200, which can represent a point where traffic usage is falling, e.g., where the cost of powering the one or more base stations is not offset by the cost savings from offloading traffic from the wireless system 1100 to the service provider system 1200. In implementations, there is period of time or a grace period needed to hand-off impacted mobile devices to the wireless system 1100 from the service provider system 1200. This can be accounted for by initiating a powering off process at a later point, i.e., power off initialization point 2250. In implementations, the graph 2000, the NPV power on threshold 2100, the power on initialization point 2150, the NPV power off threshold 2200, and the power off initialization point 2250 can be updated periodically, on-demand, and/or combinations thereof. In implementations, machine learning techniques can be used to determine and update the graph 2000, the NPV power on threshold 2100, the power on initialization point 2150, the NPV power off threshold 2200, and the power off initialization point 2250, as appropriate and applicable.

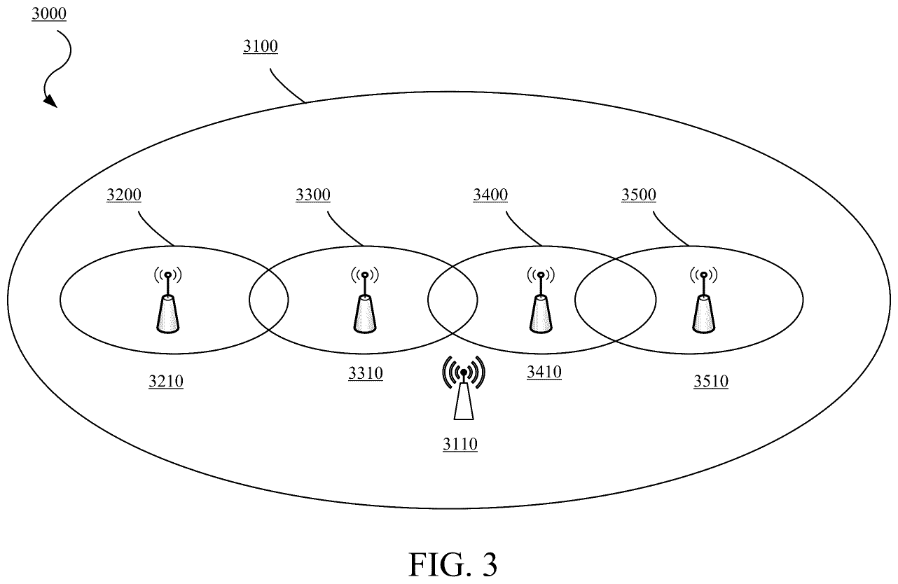

In implementations, the RPEF engine 1270 can apply a variety of factors to determine which of the candidate base stations to power on or off. In implementations, the variety of factors can include, but is not limited to, user experience, MVNO status, handoff issues, mobility issues, and coverage jumping (e.g., unwanted switching between the two networks due to powering off a middle or intermediate base station) (collectively “mobility issues or mobility issue factors”). FIG. 3 is a diagram of an example of wireless coverage areas 3000 in accordance with embodiments of this disclosure. In implementations, the wireless coverage areas 3000 can include, but is not limited to, a MVNO wireless coverage area 3100 provided by a base station 3110, and MSO or system provider coverage areas 3200, 3300, 3400, and 3500 provided by base stations 3210, 3310, 3410, and 3510, respectively. In making the decisions to turn off certain base stations, the RPEF engine 1270 can consider whether one or more mobility issues exist. In an illustrative example, assume that base station 3310 should be turned off due to the traffic usage and/or a NPV value. In this instance, powering off the base station 3310 would result in a system provider coverage area gap, where impacted mobile devices would be jumping between the MVNO wireless coverage area 3100 and the remaining system provider coverage areas 3200, 3400, and 3500. This “coverage jumping” is a scenario that the RPEF engine 1270 would avoid. In implementations, the RPEF engine 1270 can wait until the base station 3210 needs to be powered off. The RPEF engine 1270 can then power off both base stations 3210 and 3310. In implementations, the RPEF engine 1270 can wait until the base stations 3210, 3410, and 3510 need to be powered off. The RPEF engine 1270 can then power off base stations 3210, 3310, 3410, and 3510. This can be referred to as powering off of a cluster as represented by the base stations 3210, 3310, 3410, and 3510. In another illustrative example, assume that base station 3210 should be turned off due to the traffic usage and/or a NPV value. In this instance, powering off the base station 3310 would not result in a system provider coverage area gap. The RPEF engine 1270 can power off the base station 3210. In this instance, the base station 3210 is an edge base station in the cluster. Powering off of edge base stations does not result in coverage jumping. Similarly, the RPEF engine 1270 can apply the variety of factors when making decisions on which candidate base stations to power on.

The CMTS 2300 can provide cable, television, Internet, voice, and like services to premises, residences, offices, and the like (collectively “premises”) via the base stations 1220, 1230, and 1240. The CMTS 2300 can work with the RPEF engine 1270 to power on or power base station(s) as appropriate. In implementations, the CMTS 2300 can include a switch, digital switch, and/or a multiplexor to provide power/not provide power to a base station, multiple base stations, a cluster, and/or combinations thereof.

The mobile device 1400 can be, but is not limited to, Internet of Thing (IoT) devices, sensors, end user devices, cellular telephones, Internet Protocol (IP) devices, mobile computers, laptops, handheld computers, personal media devices, smartphones, notebooks, notepads, and the like, which can be provisioned for operation with a MSO, a MVNO, and/or service provider, can be provisioned for direct communication with each other and other mobile devices, and can be provided and provisioned by a service provider to operate in 3G, 4G, 5G, CBRS, and/or other wireless communication technologies and/or networks. In implementations, the mobile device 1400 can be a DSDS device for operation with the wireless or MVNO system 1100 and with the service provider system 1200.

Operationally, the RFEF engine 1270 can obtain traffic usage information via the CM 1250 and the OSS 1260. The RFEF engine 1270 can generate a list of base stations to power on and/or power off based on traffic usage, NPV values, mobility issue factors, and/or combinations thereof. The RFEF engine 1270 can send the list to the CMTS, which in turn can turn on and/or turn off power, as appropriate, to the base stations on the list.

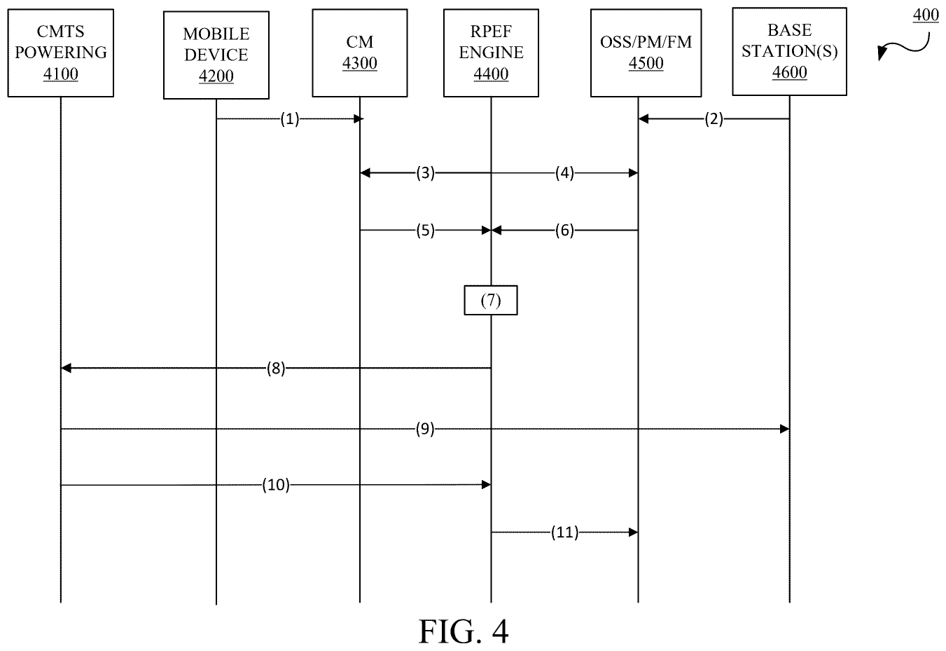

FIG. 4 is a flow 4000 of an example of a system using a power saving based on NPV in accordance with embodiments of this disclosure. The flow 4000 is performed between a CMTS 4100, a mobile device 4200, a CM 4300, a RPEF engine 4400, an OSS/PM/FM 4500, and one or more base stations and/or clusters 4600. Each of the components listed in FIG. 4 can function as described herein with respect to FIGS. 1-3.

In the flow 4000, the mobile device 4200 can provide traffic usage information to the CM 4300 (1), and the base station(s) can send traffic usage information to the OSS 4500 (2). The RPEF engine 4400 can subscribe with the CM 4300 (3) and the OSS 4500 (4) to obtain the respective traffic usage information. The CM 4300 (5) and the OSS 4500 (6) can send the traffic usage information to the RPEF engine 4400. The RPEF engine 4400 can review the traffic usage information on the service provider system (i.e., the MSO traffic usage information from the OSS 4500) to determine whether the traffic usage and/or NPV values based on the traffic usage breach or fall below a NPV power off threshold (7). In implementations, the RPEF engine 4400 applies mobility issue factors to potential base stations and/or clusters. The RPEF engine 4400 can generate a list of base station(s) and/or clusters to power off (“power off list”). The RPEF engine 4400 can send the power off list to the CMTS 4100 (8). The CMTS 4100 can switch off power at the appropriate base station(s) and/or cluster(s) 4600 (9). In implementations, there is a grace period for mobile device handoff to the MVNO network. The CMTS 4100 can notify the RPEF engine 4400 that the power to the impacted base station(s) and/or cluster(s) 4600 has been turned off (10). In implementations, the CMTS 4100 can confirm power off status using a variety of techniques. The RPEF engine 4400 can notify the OSS 4500 that the power to the impacted base station(s) and/or cluster(s) 4600 has been turned off (11). The OSS 4500 can send an alert and/or a notification to a fault management (FM) that certain base stations have been turned off.

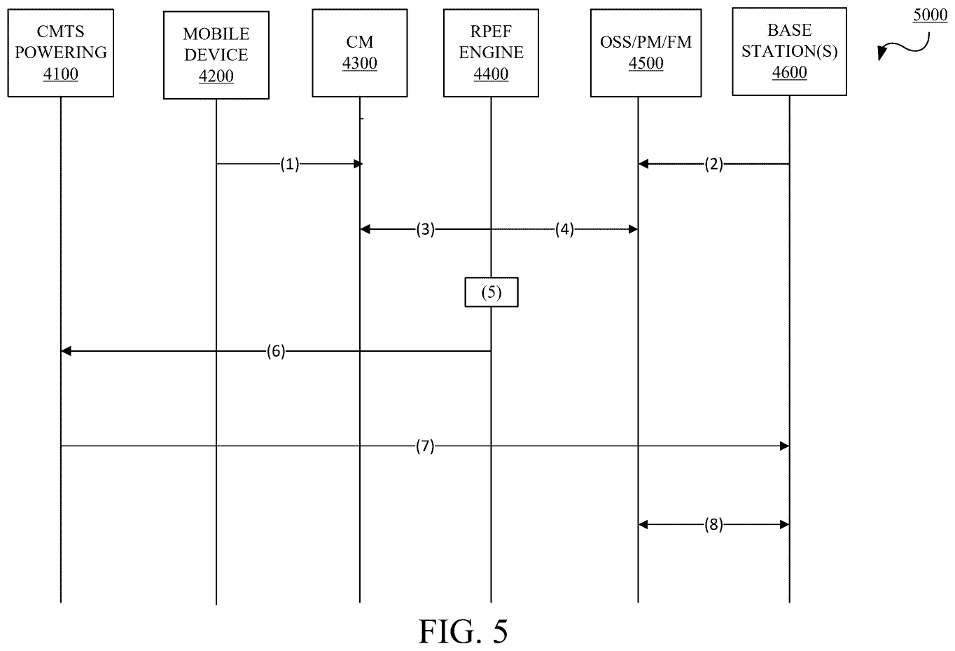

FIG. 5 is a flow 5000 of an example of a system using a power saving based on NPV in accordance with embodiments of this disclosure. The flow 5000 is performed between a CMTS 4100, a mobile device 4200, a CM 4300, a RPEF engine 4400, an OSS/PM/FM 4500, and one or more base stations and/or clusters 4600. Each of the components listed in FIG. 5 can function as described herein with respect to FIGS. 1, 2, and with the flow 4000 described in FIG. 4. The flow 5000 assumes that the RPEF engine 4400 has already subscribed with the CM 4300 and the OSS 4500 to obtain traffic usage information. If not already subscribed, then the RPEF engine 4400 can subscribe with the CM 4300 and the OSS 4500 to obtain the traffic usage information (1-4).

In the flow 5000, the RPEF engine 4400 can review the traffic usage information on the MVNO system (i.e., the MVNO traffic usage information from the CM 4300) to determine whether the traffic usage and/or NPV values based on the traffic usage meet or rise above a NPV power on threshold (7). The RPEF engine 4400 can generate a list of base station(s) and/or clusters to power on (“power on list”). In implementations, the RPEF engine 4400 applies mobility issue factors to potential base stations and/or clusters. The RPEF engine 4400 can send the power on list to the CMTS 4100 (6). The CMTS 4100 can switch on power at the appropriate base station(s) and/or cluster(s) 4600 (7). The base station(s) and/or cluster(s) 4600 can coordinate with the OSS 4500 to start the power on process (8).

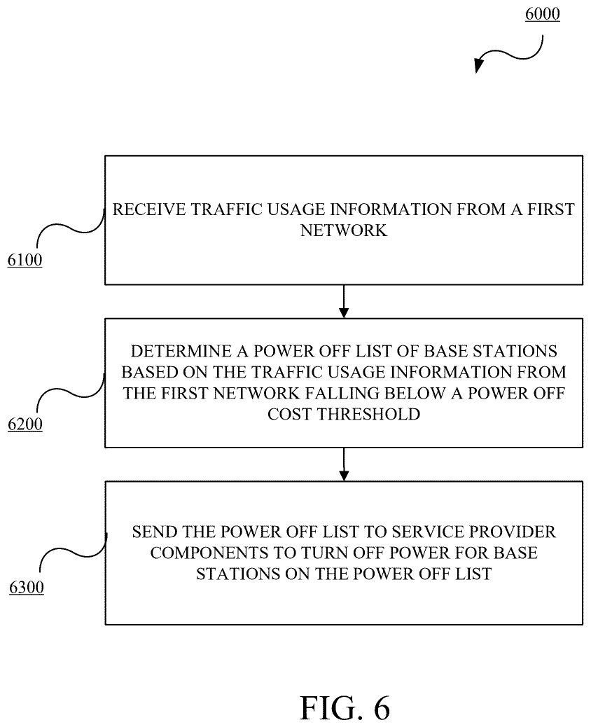

FIG. 6 is a flowchart of an example method 6000 for saving power in a hybrid or multi-network wireless network in accordance with embodiments of this disclosure. The method 6000 includes: receiving 6100 traffic usage information from a first network; determining 6200 a power off list of base stations based on the traffic usage information from the first network falling below a power off cost threshold; and sending 6300 the power off list to service provider components to turn off power for base stations on the power off list. The method 6000 can be implemented, for example, in or by components described with respect to FIGS. 1-2 and 4-5 and in conjunction with any of the flows described with respect to FIGS. 4-5 and 7, as appropriate and applicable.

The method 6000 includes receiving 6100 traffic usage information from a first network. A service provider can deploy or employ a wireless network which includes the first network and a second network. The first network is a wireless network owned and operated, and/or controlled by the service provider, e.g., an MSO network, to provide wireless service to service provider subscribers. The second network is a wireless network owned by another party or a third party and being used by the service provider to provide wireless service to the service provider subscribers. The service provider pays fees to the owner of the second network, i.e., the another party or the third party, to use the second network. In implementations, wireless coverage areas of the first network and the second network can overlap substantially, partially, and/or fully. The first network and the second network can include base stations. The base stations in the first network can be powered off by the service provider as described herein. A RPEF engine can obtain and/or receive the traffic usage information from the base stations in the first network via an OSS. The RPEF engine can obtain and/or receive the traffic usage information from mobile devices using the second network via a CM.

The method 6000 includes determining 6200 a power off list of base stations based on the traffic usage information from the first network falling below a power off cost threshold. The RPEF engine can maintain a power off cost threshold, which is a point where the cost of powering the base stations in the first network is substantially equal to the savings cost obtained by offloading traffic from the second network to the first network. In implementations, the power off cost threshold is a NPV power off cost threshold. The RPEF engine can compare the traffic usage information from the first network, NPV values for the traffic usage information from the first network, and/or combinations thereof to generate a power off list of base stations. In implementations, the RPEF engine can further apply mobility issue factors to determine the power off list.

The method 6000 includes sending 6300 the power off list to service provider components to turn off power for base stations on the power off list. The service provider components can include, but is not limited to, a CMTS. The service provider components can switch off power at a base station level and/or at a cluster level.

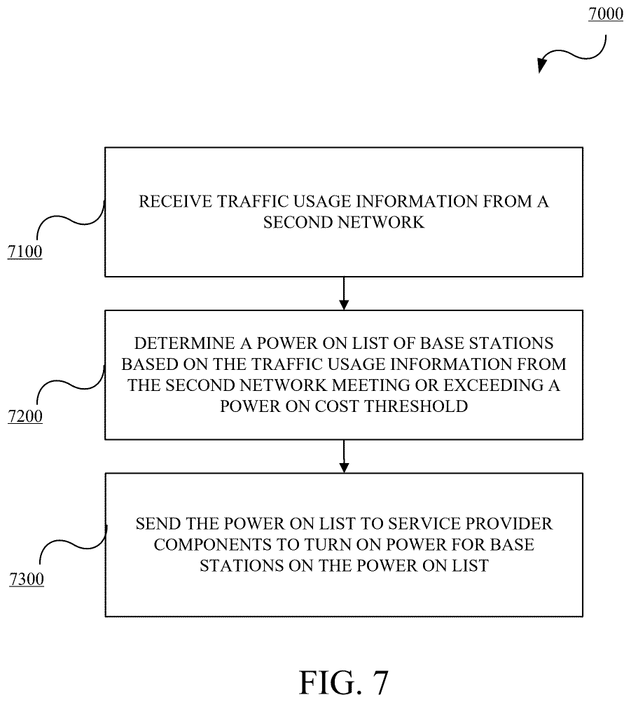

FIG. 7 is a flowchart of an example method 7000 saving power in a hybrid or multi-network wireless network in accordance with embodiments of this disclosure. The method 7000 includes: receiving 7100 traffic usage information from a second network; determining 7200 a power on list of base stations based on the traffic usage information from the second network meeting or exceeding a power on cost threshold; and sending 7300 the power on list to service provider components to turn on power for base stations on the power on list. The method 7000 can be implemented, for example, in or by components described with respect to FIGS. 1-2 and in conjunction with any of the flows described with respect to FIGS. 3-6, as appropriate and applicable.

The method 7000 includes receiving 7100 traffic usage information from a second network. A service provider can deploy a wireless network which includes a first network and the second network. The first network is a wireless network owned and operated, and/or controlled by the service provider, e.g., an MSO network, to provide wireless service to service provider subscribers. The second network is a wireless network owned by another party or a third party and being used by the service provider to provide wireless service to the service provider subscribers. That is, it is not controlled by the service provider. The service provider pays fees to the owner of the second network, i.e., the another party or the third party, to use the second network. In implementations, wireless coverage areas of the first network and the second network can overlap substantially, partially, and/or fully. The first network and the second network can include base stations. The base stations in the first network can be powered off by the service provider as described herein. A RPEF engine can obtain and/or receive the traffic usage information from the base stations in the first network via an OSS. The RPEF engine can obtain and/or receive the traffic usage information from mobile devices using the second network via a CM.

In implementations, the method 7000 includes determining 7200 a power on list of base stations based on the traffic usage information from the second network meeting or exceeding a power on cost threshold. The RPEF engine can maintain a power on cost threshold, which is a point where the cost of powering the base stations in the first network is substantially equal to the savings cost obtained by offloading traffic from the second network to the first network. In implementations, the power on cost threshold is a NPV power on cost threshold. The RPEF engine can compare the traffic usage information from the second network, NPV values for the traffic usage information from the second network, and/or combinations thereof to generate a power on list of base stations. In implementations, the RPEF engine can further apply mobility issue factors to determine the power on list.

In implementations, the method 7000 includes sending 7300 the power on list to service provider components to turn on power for base stations on the power on list. The service provider components can include, but is not limited to, a CMTS. The service provider components can switch on power at a base station level and/or at a cluster level.

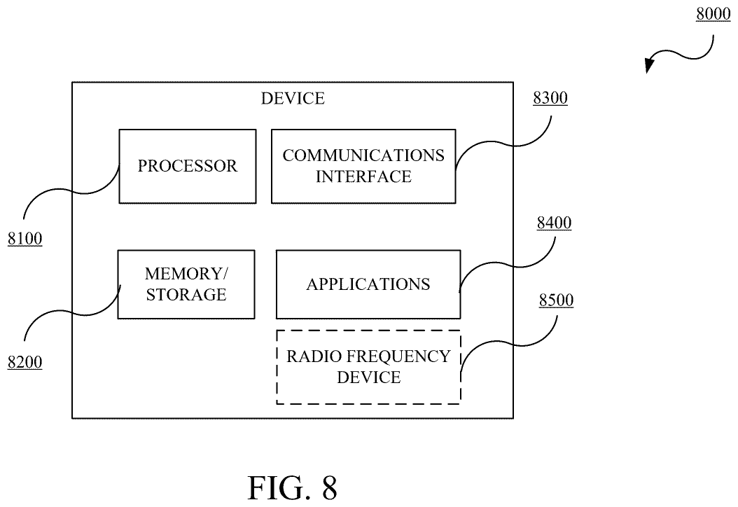

FIG. 8 is a block diagram of an example of a device 8000 in accordance with embodiments of this disclosure. The device 8000 may include, but is not limited to, a processor 8100, a memory/storage 8200, a communication interface 8300, applications 8400, and, if needed, a radio frequency device(s) 8500. The device 8000 may include or implement, for example, the systems and components described with respect to FIGS. 1 and 4-5 and the implement the methods of FIGS. 4-6. The applicable or appropriate flows, techniques, or methods described herein may be stored in the memory/storage 8200 and executed by the processor 8100 in cooperation with the memory/storage 8200, the communications interface 8300, the applications 8400, and the radio frequency device 8500 (when applicable), as appropriate. The device 8000 may include other elements which may be desirable or necessary to implement the devices, systems, and methods described herein. However, because such elements and steps do not facilitate a better understanding of the disclosed embodiments, a discussion of such elements and steps may not be provided herein.

Described herein is a method for saving power in a hybrid mobile network in view of traffic usage and operational costs. The method includes deploying, by a service provider, a first wireless network and a second wireless network, wherein the first wireless network is owned and operated by the service provider and the second wireless network is used by the service provider for a fee, receiving, by a cost power engine from an operations support system, traffic usage information from one or more base stations of the first wireless network, generating, by the cost power engine, a power off list based on the traffic usage information falling below a cost power off threshold, and sending, by the cost power engine to service provider components, the power off list to turn off power to base stations on the power off list.

In implementations, the method further includes subscribing, by the cost power engine with the operations support system, to messages including the traffic usage information. In implementations, the generating further includes applying, by the cost power engine, mobility issue factors during generation of the power off list. In implementations, the mobility issue factors prevent powering off a base station which is a middle base station in a cluster of base stations. In implementations, the mobility issue factors permit powering off a base station which is an edge base station in a cluster of base stations. In implementations, the cost power off threshold is a point where a cost to power a base station is substantially offset by savings gained by offloading traffic from the second wireless network to the first wireless network. In implementations, the cost power off threshold is a net present value of a cost to power a base station as compared to savings gained by offloading traffic from the second wireless network to the first wireless network. In implementations, a net present value is determined from the traffic usage information, the cost power off threshold is a net present value power off threshold, and the generating further includes comparing the net present value to the net present value power off threshold to generate the power off list. In implementations, the method further includes receiving, by the cost power engine from a connection manager, traffic usage information from one or more mobile devices operating in the second wireless network, generating, by the cost power engine, a power on list based on the traffic usage information from the connection manager meeting or exceeding a cost power on threshold, and sending, by the cost power engine to service provider components, the power on list to turn on power to base stations on the power on list. In implementations, the method further includes subscribing, by the cost power engine with the connection manager, to messages including the traffic usage information from the one or more mobile devices. In implementations, the cost power on threshold is a point where a cost to power a base station is substantially offset by savings gained by offloading traffic from the second wireless network to the first wireless network. In implementations, the service provider components delay a grace period to enable mobile devices to handoff to the second wireless network from the base stations on the power off list.

Described herein is a system for saving power in a hybrid mobile network in view of traffic usage and operational costs. The system includes a service provider network including one or more base stations, a wireless network used by the service provider, and a cost power controller. The cost power controller configured to obtain, from an operations support system, traffic utilization data from the one or more base stations, determine which of the one or more base stations have traffic utilization data that breaches a cost power off threshold, and notify service provider components to turn off power for a base station having traffic utilization data that breaches the cost power off threshold.

In implementations, the cost power controller further configured to subscribe to traffic utilization data from the operations support system. In implementations, for the base station, the cost power controller further configured to forego notification to the service provider components if the base station is impacted by a mobility issue factor. In implementations, the mobility issue factors prevent powering off a base station which is a middle base station in a cluster of base stations and the mobility issue factors permit powering off a base station which is an edge base station in a cluster of base stations. In implementations, the cost power off threshold is a point where a cost to power a base station is substantially offset by savings gained by offloading traffic from the wireless network to the service provider network. In implementations, the cost power off threshold is a net present value power off threshold and the cost power controller further configured to determine a net present value of traffic utilization data, and send notification to the service provider components when the net present value breaches the net present value power off threshold. In implementations, the cost power controller further configured to obtain, from a connection manager, traffic utilization data from mobile devices operating in the wireless network, determine which of the one or more base stations have traffic utilization data from the connection manager that meets or exceeds a cost power on threshold, and notify the service provider components to turn on power for a base station having traffic utilization data from the connection manager that meets or exceeds the cost power on threshold. In implementations, the cost power on threshold is a point where a cost to power a base station is substantially offset by savings gained by offloading traffic from the wireless network to the service provider network.

Although some embodiments herein refer to methods, it will be appreciated by one skilled in the art that they may also be embodied as a system or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects may take the form of a computer program product embodied in one or more the computer readable mediums having the computer readable program code embodied thereon. For example, the computer readable mediums can be non-transitory. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

As used herein, the term “computer-readable medium” encompasses one or more computer-readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

Computer program code for carrying out operations for aspects may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects are described herein with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain embodiments, it is to be understood that the disclosure is not to be limited to the disclosed embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

What is claimed is:

1. A method for power savings in a wireless network, the method comprising:
employing, by a service provider, a first wireless network and a second wireless network, wherein the first wireless network is controlled by the service provider and the second wireless network is not controlled by the service provider; and
receiving, by a cost power engine from an operations support system, traffic usage information from one or more base stations of the first wireless network,
wherein the traffic usage information is used to turn off power to one or more base stations in the first wireless network.

2. The method of claim 1, further comprising:
subscribing, by the cost power engine with the operations support system, to messages including the traffic usage information.

3. The method of claim 1, further comprising:
generating, by the cost power engine, a power off list based on the traffic usage information falling below a cost power off threshold; and
sending, by the cost power engine to service provider components, the power off list to turn off power to base stations on the power off list.

4. The method of claim 3, the generating further comprising:
applying, by the cost power engine, mobility issue factors during generation of the power off list.

5. The method of claim 4, wherein the mobility issue factors prevent powering off a base station which is a middle base station in a cluster of base stations.

6. The method of claim 4, wherein the mobility issue factors permit powering off a base station which is an edge base station in a cluster of base stations.

7. The method of claim 3, wherein the cost power off threshold is a point where a cost to power a base station is substantially offset by savings gained by offloading traffic from the second wireless network to the first wireless network.

8. The method of claim 3, wherein the cost power off threshold is a net present value of a cost to power a base station as compared to savings gained by offloading traffic from the second wireless network to the first wireless network.

9. The method of claim 3, wherein a net present value is determined from the traffic usage information, the cost power off threshold is a net present value power off threshold, and the generating further comprising:
comparing the net present value to the net present value power off threshold to generate the power off list.

10. The method of claim 1, further comprising:
receiving, by the cost power engine from a connection manager, traffic usage information from one or more mobile devices operating in the second wireless network,
wherein the traffic usage information from connection manager is used to turn on power to one or more base stations in the first wireless network.

11. The method of claim 10, further comprising:
generating, by the cost power engine, a power on list based on the traffic usage information from the connection manager meeting or exceeding a cost power on threshold; and
sending, by the cost power engine to service provider components, the power on list to turn on power to base stations on the power on list.

12. The method of claim 10, further comprising:
subscribing, by the cost power engine with the connection manager, to messages including the traffic usage information from the one or more mobile devices.

13. The method of claim 11, wherein the cost power on threshold is a point where a cost to power a base station is substantially offset by savings gained by offloading traffic from the second wireless network to the first wireless network.

14. The method of claim 1, wherein a grace period is used to enable mobile devices to handoff to the second wireless network from the one or more base stations.

15. A service provider system, comprising:
a service provider network including one or more base stations;
a wireless network used by the service provider;
a cost power controller configured to:
obtain, from an operations support system, traffic utilization data from the one or more base stations;
determine which of the one or more base stations have traffic utilization data that breaches a cost power off threshold; and
notify service provider components to turn off power for a base station having traffic utilization data that breaches the cost power off threshold.

16. The system of claim 15, the cost power controller further configured to:
subscribe to traffic utilization data from the operations support system.

17. The system of claim 15, for the base station, the cost power controller further configured to:
forego notification to the service provider components if the base station is impacted by a mobility issue factor.

18. The system of claim 17, wherein mobility issue factors prevent powering off a base station which is a middle base station in a cluster of base stations and the mobility issue factors permit powering off a base station which is an edge base station in a cluster of base stations.

19. The system of claim 15, wherein the cost power off threshold is a point where a cost to power a base station is substantially offset by savings gained by offloading traffic from the wireless network to the service provider network.

20. The system of claim 15, wherein the cost power off threshold is a net present value power off threshold and the cost power controller further configured to:
determine a net present value of traffic utilization data; and
send notification to the service provider components when the net present value breaches the net present value power off threshold.

21. The system of claim 15, the cost power controller further configured to:
obtain, from a connection manager, traffic utilization data from mobile devices operating in the wireless network;
determine which of the one or more base stations have traffic utilization data from the connection manager that meets or exceeds a cost power on threshold; and
notify the service provider components to turn on power for a base station having traffic utilization data from the connection manager that meets or exceeds the cost power on threshold.

22. The system of claim 21, wherein the cost power on threshold is a point where a cost to power a base station is substantially offset by savings gained by offloading traffic from the wireless network to the service provider network.
